(19) United States
(12) Patent Application Publication
(10) Pub. No.: US 2021/0086916 A1
(43) Pub. Date: Mar. 25, 2021

(54) AIRCRAFT MONITORING SYSTEM AND METHOD FOR COLLECTING DATA ON AIRCRAFT MAINTENANCE

(71) Applicant: Rolls-Royce Deutschland Ltd & Co KG, Blankenfelde-Mahlow (DE)

(72) Inventors: Raphael Levy CARVALHO DO LAGO, Blankenfelde-Mahlow (DE); Ladislav PETRIC, Trebbin OT Schönhagen (DE)

(73) Assignee: Rolls-Royce Deutschland Ltd & Co KG, Blankenfelde-Mahlow (DE)

(21) Appl. No.: 16/761,959

(22) PCT Filed: Nov. 8, 2018
(86) PCT No.: PCT/EP2018/080652

§ 371 Date: May 6, 2020

(30) Foreign Application Priority Data
Nov. 17, 2017 (DE) 10 2017 127 142.2

(51) Int. Cl. B64F 5/60; B64F 5/40; G05B 23/02; G06Q 10/00

(52) U.S. Cl. CPC B64F 5/60; B64F 5/40; G07C 5/006; G06Q 10/20; G05B 23/0283

(57) ABSTRACT

An aircraft monitoring system which includes: at least one Line Replaceable Unit (LRU) installed in an aircraft unit, the LRU comprising a Radio Frequency Identification (RFID) tag, the RFID tag containing stored information which consists of or comprises ID-information identifying the LRU; and an RFID reader installed in the aircraft unit, the RFID reader being configured to at least intermittently automatically read the RFID tag of the at least one LRU. The RFID reader is configured to transmit at least the read ID-information to an aircraft communication unit that participates in sending the ID-information to a remote surveillance system. Further aspects of the invention regard a method and a surveillance system for collecting data on aircraft maintenance.

The invention regards an aircraft monitoring system and a method for collecting data on aircraft maintenance.

A Line Replaceable Unit (LRU) is a modular component of a manufactured device that is designed to be replaced quickly and individually at an operating location. In the context of aircrafts, an LRU is a unit that can be removed and re-fitted from an aircraft in field.

Typically, LRUs are replaced by aircraft mechanics from airlines or from third parties due to faulty conditions demonstrated by these units. A faulty condition is usually presented by a malfunction of a system or maintenance fault code shown in the aircraft cockpit. In an aircraft engine, this fault is generated by the Electronic Engine Control (EEC) unit (which is an LRU by itself) that monitors health status from the other LRUs and issues a fault code to the cockpit. This fault code is then addressed by line maintenance troubleshooting described in a Fault Isolation Manual (a part of the Aircraft Maintenance Manual).

Typically, part of the troubleshooting is to remove the LRU, send it to repair or troubleshooting quarantine and install a serviceable LRU. During this removal installation transaction important information can be obtained like the LRU component accumulated hours and cycles, the location of removal, the environment it operated in, the time it took the mechanics to remove the LRU and install a new LRU, etc.

An LRU removal and replacement may be not digitally recorded at all, it may be digitally recorded after the fact (up to a few weeks) or it may be digitally recorded in a format not compatible with formats and software used by the aircraft engine manufacturer. It may also be the case that some parameters that are important to the aircraft engine manufacturer are not recorded at all. All this generates a high amount of extra efforts to track LRU components and to obtain the required information about replaced LRUs, and in many cases this task cannot be addressed properly. At the same time, asset management is essential to ensure product support over its lifecycle.

For product supportability it is essential to have a clear view on the reliability of units coped with its operational environment, unit age, maintainability information and root cause understanding of failures. For such a close understanding of asset location is necessary.

Document US 2016/0196457 A1 discloses an LRU health node having an RFID module and sensors that monitor operational parameters of several LRUs. The LRU health node gathers data on the LRUs and stores the data locally in a mass storage memory. The stored data can be read by an RFID scanner which may determine a maintenance action by forwarding the data over a digital network to a remotely located maintenance support center. US 2016/0196457 A1 thus discloses the use of a single RFID tag for storing health information about various components of an aircraft engine.

The problem underlying the present invention is to provide systems and methods that improve lifecycle management of LRUs of aircraft units.

This problem is solved by an aircraft monitoring system with the features of claim 1, a method for collecting data on aircraft maintenance with the features of claim 13, a surveillance system for collecting data on aircraft maintenance with the features of claim 17 and a software application product with the features of claim 21. Embodiments of the invention are identified in the dependent claims.

According to an aspect of the invention, an aircraft monitoring system is provided which comprises at least one Line Replaceable Unit (LRU) installed in an aircraft unit. The LRU comprises a Radio Frequency Identification (RFID) tag. The RFID tag contains stored information which consists of or comprises identification information (ID-information) identifying the LRU. The aircraft monitoring system further comprises an RFID reader installed in the aircraft unit, the RFID reader being configured to at least intermittently automatically read the RFID tag of the at least one LRU. Further, the RFID reader is configured to transmit at least the read ID-information to an aircraft communication unit that participates in sending the ID-information to a remote surveillance system.

The invention thus provides for a maintenance system in which RFID tags are included in the LRUs, wherein the RFID tags identify the LRUs, and in which the RFID tags are read by an RFID reader installed in the aircraft unit automatically and at least intermittently. The captured information/data is transmitted to a remote surveillance system. The invention allows to identify any replacements of LRUs as, after a replacement, the ID of the LRU has changed. The invention thus provides for an automatic and service personal independent means to identify at a remote surveillance system when an aircraft LRU was removed and a new one has been installed. The remote surveillance system may be a unit associated with the manufacturer of the aircraft unit. It may be a central or decentralized computer system.

The automatic capture of an aircraft unit LRU replacement that occurs in the course of a service operation may be used for different purposes in a company, such as reliability assessments and lifecycle management.

Another advantage associated with the invention lies in that, as the LRU is identified by an RFID tag, it is not necessary anymore to print identification codes such as a barcode, a QR code or a data matrix code on the LRU.

In an embodiment of the invention, the aircraft unit in which the LRUs and the RFID reader are installed is an aircraft engine (such as a turbofan engine). However, the invention is not limited to such embodiment. In other embodiments, e.g., the aircraft unit in which the LRUs and the RFID reader are installed is a Landing Gear Unit (the LRUs being, e.g., hydraulic pumps or hydraulic actuators) or an Engine Vibration Monitoring Unit (the LRUs being, e.g., accelerometers installed in the aircraft that acquire and process signals).

The RFID reader is configured to automatically read the RFID tags of the LRUs at least intermittently. In an embodiment of the invention, the RFID reader is configured to read the RFID tag periodically. The term “periodically” is to be understood in a broad manner. It may mean that the RFID tags are read after defined time intervals but it may also mean that the RFID tags are read triggered by any event that occurs repeatedly. For example, it may be provided that the RFID reader is configured to read the RFID tag upon each start of the aircraft or aircraft engine. This provides for an efficient reading of the RFID tags as the start of the aircraft is the first time an LRU is used after maintenance and possible replacement of the LRU.

The RFID tag may be a passive or semi-active tag according to some embodiments of the invention. Alternatively, it may be an active tag. Active and semi-passive RFID tags use internal batteries to power their circuits. An active tag also uses its battery to broadcast radio waves to a reader, whereas a semi-passive tag relies on the reader to supply its power for broadcasting. Which kind of RFID tag to use depends on the available signal strength. For example, if the RFID reader which is at a fixed location in the aircraft unit is distant from the LRU and/or shielding components are located between the RFID reader and the LRU, it may be preferable to use a semi-active tag rather than a passive tag. Naturally, passive tags are preferred for cost reasons if the signal strength they provide is sufficient for a safe reading.

The RFID tags used in the present invention are of conventional design as well known to the skilled person. In particular, an RFID tag may comprise the following elements: an integrated circuit that is configured to store and process information that modulates and demodulates radio-frequency signals; a circuit that is configured to collect power from a reader signal that is incident and/or a battery; and an antenna that is suitable to receive and transmit the signal. The tag information is stored in a memory. The tag information includes ID-information that identifies the LRU to which the tag is attached or into which it is integrated. The tag information may consist solely of ID-information in the simplest form of the invention. ID-information may be, e.g., a unique tag serial number or the like. Alternatively, additional information about the LRU may be stored in the RFID tag. In an exemplary embodiment of the invention, the RFID tag is embedded in hardware of the LRU. This avoids the risk that the RFID tag may be dislocated from the LRU.

The RFID reader may be located at any suitable location within the aircraft unit. Due to the fact that the read information is transmitted to an aircraft communication unit that participates in sending the ID-information to a remote surveillance system, the RFID reader is located in an exemplary embodiment of the invention inside, outside or near an Electronic Control Unit of the aircraft unit (such as the Electronic Engine Control (EEC) in case of an aircraft engine), wherein the Electronic Control Unit unit represents such aircraft communication unit. More particularly, the RFID reader may be integrated with other electronic components inside the Electronic Control Unit. Alternatively, the RFID reader may be separate component from the Electronic Control Unit and be located outside of the Electronic Control Unit (it may, e.g., be attached to the housing of the Electronic Control Unit) or be located near the Electronic Control Unit. In the latter cases, it may be provided that the RFID reader is wire connected to the Electronic Control Unit and that the RFID reader and the Electronic Control Unit communicate via a bus. Further, it is pointed out that in other embodiments the RFID reader may located remote from the Electronic Control Unit in the aircraft, e.g., in the engine nacelle, in the pylon or in the aircraft fuselage.

It is pointed out that a considered aircraft unit such as an aircraft engine may have one or several RFID readers, each RFID reader reading at least intermittently and automatically the RFID tag of at least one LRU. If several RFID readers are present in a unit, each RFID reader can read the RFID tags of the LRUs closest to it, thereby ensuring sufficient signal strength for the communication between readers and tags.

It is further pointed out that within the meaning of the present invention an RFID reader is considered a part of and installed in an aircraft unit when it is able to read signals of RFID tags of LRUs of that unit.

According to an exemplary embodiment, the aircraft communication unit to which the RFID reader transmits the information read from the RFID tag is an electronic control unit of the aircraft unit (such as the Electronic Engine Control (EEC) in case of an aircraft engine) or an on-board communication unit located in the aircraft. Accordingly, in one embodiment the information read by the RFID reader is transmitted to such electronic control unit. Typically, the electronic control unit communicates with an on-board communication unit that sends the information to ground. In another embodiment, the information read by the RFID reader is transmitted directly to such on-board communication unit without the information passing through the electronic control unit. To this end, a direct communication is established in such case between the RFID reader and the on-board communication unit which may be a wire based or wireless communication.

In an embodiment of the present invention, the aircraft communication unit to which the RFID reader transmits the ID-information read from the RFID tag (which may be an electronic control unit such as the EEC or an on-board communication unit as mentioned above) is designed and configured to participate in transmitting the read ID-information to the remote surveillance system by means of an Health Monitoring system that has been implemented to transmit health information about aircraft components to the remote surveillance system. Such Health Monitoring system is state of the art. The idea of such Health Monitoring system is to collect data about engine or other aircraft components through sensors and to transmit these data to ground to a surveillance system. Such transmission may take place, e.g., through a wireless local area network if the airplane is on ground, or take place, e.g., through satellite communication if the airplane is in the air. The health data is typically collected at an electronic control unit such as the EEC and transmitted from the electronic control unit to an on-board communication unit located in the aircraft, from which it is transmitted to ground.

According to the mentioned embodiment of the invention, the data transmission through the Health Monitoring system is used also to transmit the ID-information (and, if present, further information stored in the RFID tag) read from the RFID tags to the remote surveillance system. This is associated with the advantage that no additional data transmission system has to be established.

As mentioned, the read information allows to identify any replacements of LRUs as, after a replacement, the ID of an LRU has changed. In principal, the logical evaluation and analysis that an LRU has been replaced may take place either at the RFID reader itself (if sufficiently intelligent), at the aircraft communication unit (e.g., the EEC) and/or at the remote surveillance system. According to an embodiment of the invention, it is the aircraft communication unit to which the RFID reader transmits the ID-information that is configured to determine from the ID-information if an LRU has been replaced. In case of such replacement, the replacement information is transmitted together with the read ID-information to the remote surveillance system. The intelligence to determine if an LRU has been replaced is thus located in the EEC or in another aircraft unit. This is associated with the advantage that, if a replacement is detected, additional information about the replaced LRU present at the aircraft unit may be sent to the remote surveillance system along with the ID-information.

According to a further embodiment, the communication unit is also configured to link ID-information regarding an LRU (or a replacement information deducted from such ID-information) with at least one of the following additional information: accumulated hours and/or cycles of the LRU before removal, location of removal of the LRU, and time of removal of the LRU. Such additional information that is linked to the ID information may be available through sensors or other devices or may be deducted from the replacement information. For example, the accumulated hours and/or cycles of an LRU may be determined from the time interval between installation of the LRU and its replacement that has just been determined. The location of removal may be determined by a GPS unit included in the electronic control unit or somewhere else in the airplane. The time of removal may be approximated by the time at which the RFID tag of an LRU is read by an RFID reader.

The additional information may be transmitted together with the read ID-information and/or the replacement information to the remote surveillance system such that the remote surveillance system has additional information about the LRUs to improve lifecycle management.

According to a further aspect of the invention, a method for collecting data on aircraft maintenance is provided, the method comprising:
automatically reading at least intermittently by means of an RFID reader which is located in an aircraft unit ID-information contained in at least one Radio Frequency Identification (RFID) tag comprised in a Line Replaceable Unit (LRU) of the aircraft unit, each RFID tag containing ID-information identifying the respective LRU, and
transmitting the read ID-information to a remote surveillance system.

In an exemplary embodiment of method, the read ID-information is transmitted to the remote surveillance system by means of a Health Monitoring system that transmits health information about aircraft components from the aircraft to the remote surveillance system. Such Health Monitoring system may be an Engine Health Monitoring system.

The ID information read from the RFID tag is interpreted to determine if an LRU of the aircraft unit has been replaced. As discussed before, such determination may be made at different points, e.g., at an EEC or the remote surveillance system. In any case, the replacement information is gathered at the remote surveillance system.

In an embodiment, the aircraft unit is an aircraft engine such that the method is a method for collecting data on aircraft engine maintenance.

According to a further embodiment of the method, ID-information regarding an LRU (or a replacement information deducted therefrom) is linked with at least one of the following additional information: accumulated hours and/or cycles of the LRU before removal, location of removal of the LRU, time of removal of the LRU, and time to remove the LRU and install a replacement LRU. Such additional information that is linked to the ID information may be available through sensors or other devices or may be deducted from the replacement information. Further, such additional information may be provided by an aircraft mechanic. For example, when replacing an LRU, an aircraft mechanic may note the time to remove the LRU and install the replacement LRU. This information may be linked to the ID of the LRU.

According to a further aspect of the invention, a surveillance system for collecting data on aircraft maintenance is provided, wherein the surveillance system is configured to receive from an aircraft communication unit ID-information regarding at least one LRU of an aircraft unit (such as an aircraft engine), wherein each ID-information is contained in an RFID tag of an LRU and identifies an LRU. The surveillance system is further configured to determine from the received ID-information if an LRU has been replaced by a new LRU. In this aspect of the invention, the intelligence to determine if an LRU has been replaced is located in the surveillance system.

To carry out the mentioned operations, the surveillance system may comprise a processor and a memory communicatively coupled with the processor, the memory storing instructions which, when executed by the processor, perform the mentioned operations of receiving from an aircraft communication unit ID-information regarding at least one LRU of an aircraft unit and of determining from the received ID-information if an LRU has been replaced.

According to an embodiment of the surveillance system, the surveillance system is further configured to link a replacement information regarding an LRU with at least one of the following additional information: accumulated hours and/or cycles of the LRU before removal, location of removal of the LRU, time of removal of the LRU, time to remove the LRU and install and replacement LRU. As mentioned before, such additional information may be available through sensors or other devices, may be deducted from the replacement information, or may be made available through aircraft mechanics or other service personal.

Accordingly, one exemplary embodiment provides that the surveillance system is further configured to provide ID-information or information deducted therefrom (such as troubleshooting instructions) to service personal units (which may be a mobile device such as a smartphone or tablet computer with an appropriate app installed) for use of such information by service personal when maintaining the LRU, and to receive from such service personal units additional information about LRUs and maintenance work performed thereon. According to this aspect, the surveillance system is thus further configured for a communication to and from service personal units, wherein such communication serves to collect additional data about an LRU and/or to use the received ID information on replaced LRUs to improve maintenance services.

A further embodiment provides that the surveillance system is further configured to receive information from a stock or repair facility about a replaced LRU, the stock or repair facility identifying a replaced LRU by means of its RFID tag. Thereby, additional information about the present location of a replaced LRU can be collected at the surveillance system.

According to a still further aspect of the invention, a software application product is provided that is storable and operable in a mobile device that includes a graphical user interface, the software application product when executed on a processor in the mobile device being operative to:
receive from a remote surveillance system information on at least one Line Replaceable Unit (LRU) of an aircraft unit that has been or that shall be replaced, the information including identification (ID) information contained in a Radio Frequency Identification (RFID) tag comprised in the LRU,
provide to the remote surveillance system information about such LRU (e.g., condition upon removal, visible damages or colour changes, etc.) and/or maintenance work performed thereon (e.g., time spent to replace).

The mobile device includes a non-transitory computer-readable medium storing instructions for operating the mobile device, wherein the instructions, when executed by one or more processors of the mobile device, cause the processors to perform operations in the mobile device that comprise the mentioned operations.

This aspect of the invention provides for an app in a mobile device of a service personal that allows communication between the mobile device and the remote surveillance system with respect to information regarding an LRU that has been or that is to be replaced.

The invention will be explained in more detail on the basis of exemplary embodiments with reference to the accompanying drawings in which:

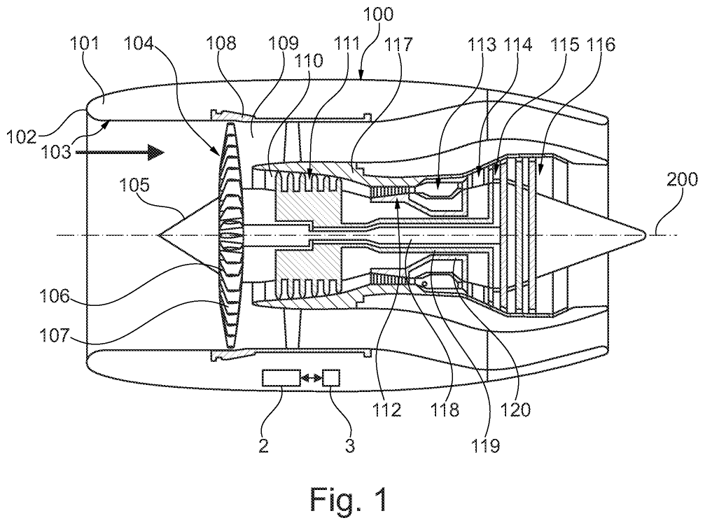

FIG. 1 is a simplified schematic sectional view of a turbofan engine in which the present invention can be realized;

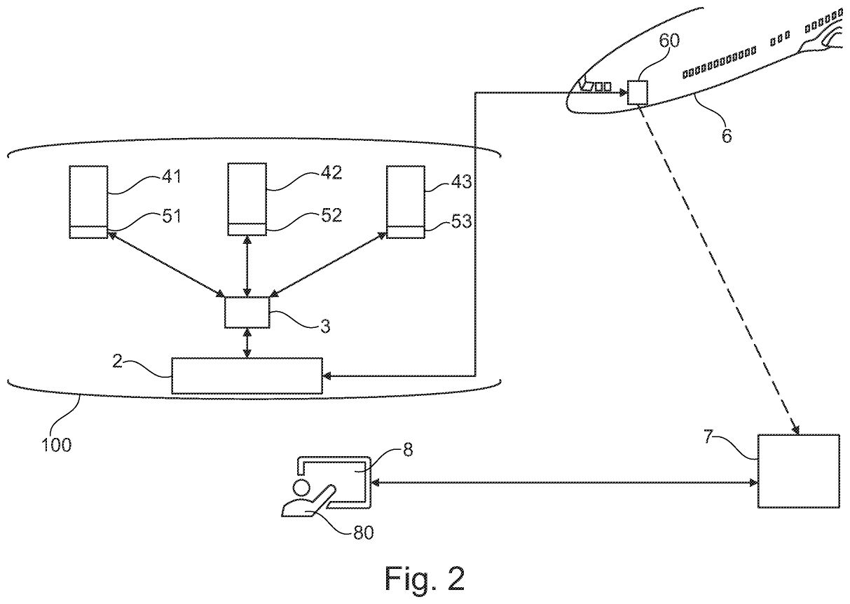

FIG. 2 shows schematically an embodiment of an aircraft engine monitoring system that comprises Line Replaceable Units (LRUs) each having an RFID tag, a RFID reader, an Electronic Engine Control (EEC) unit, in airplane communication unit and a remote surveillance system;

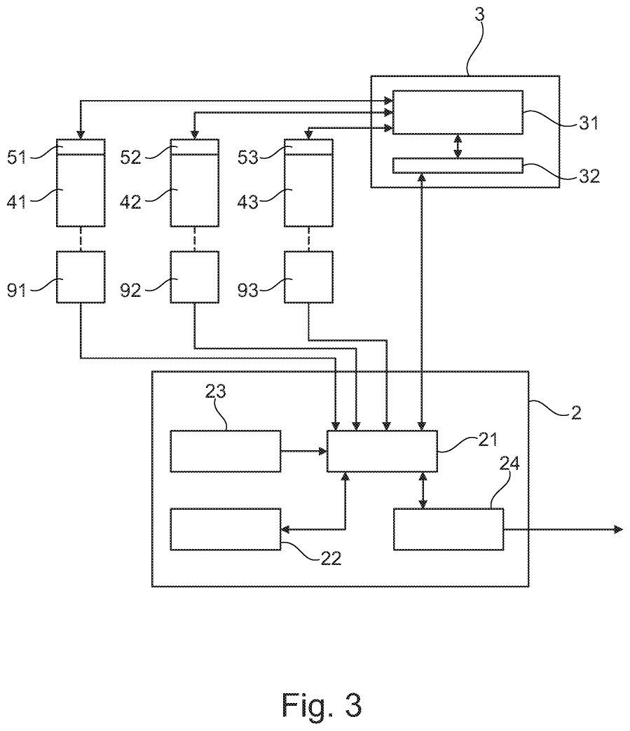

FIG. 3 shows the LRUs, the RFID reader and the EEC of FIG. 2 in more detail;

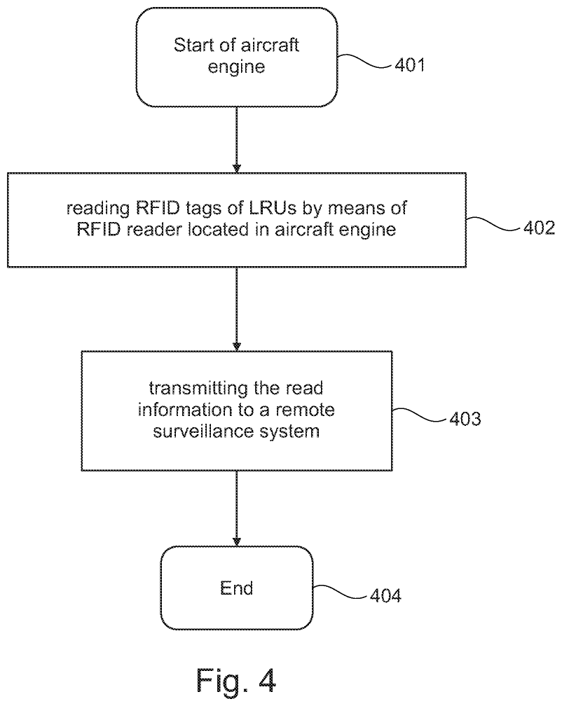

FIG. 4 is a flowchart of a method to transmit information stored in RFID tags to a remote surveillance system; and

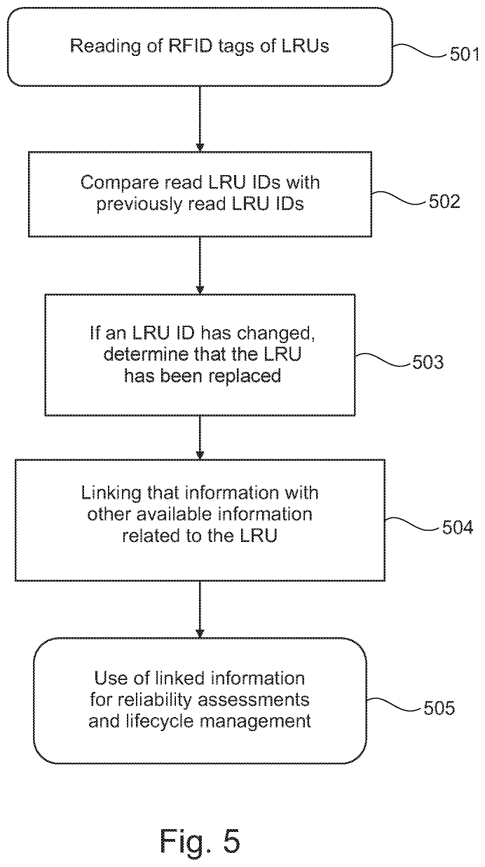

FIG. 5 is a flowchart of a method to determine from information received from RFID tags if an LRU has been replaced.

FIG. 1 shows, in a schematic manner, a turbofan engine 100 that has a fan stage with a fan 104 as the low-pressure compressor, a medium-pressure compressor 111, a high-pressure compressor 112, a combustion chamber 113, a high-pressure turbine 114, a medium-pressure turbine 115, and a low-pressure turbine 116.

The medium-pressure compressor 111 and the high-pressure compressor 112 respectively have a plurality of compressor stages that respectively comprise a rotor stage and a stator stage. The turbofan engine 100 of FIG. 1 further has three separate shafts, a low-pressure shaft 118 that connects the low-pressure turbine 116 the fan 104, a medium-pressure shaft 119 that connects the medium-pressure turbine 115 to the medium-pressure compressor 111, and a high-pressure shaft 120 that connects the high-pressure turbine 114 to the high-pressure compressor 112. However, this is to be understood to be merely an example. If, for example, the turbofan engine has no medium-pressure compressor and no medium-pressure turbine, only a low-pressure shaft and a high-pressure shaft would be present.

The turbofan engine 100 has an engine nacelle 101 that comprises an inlet lip 102 and forms an engine inlet 103 at the inner side, supplying inflowing air to the fan 104. The fan 104 has a plurality of fan blades 107 that are connected to a fan disc 106. The annulus of the fan disc 106 forms the radially inner boundary of the flow path through the fan 104. Radially outside, the flow path is delimited by the fan housing 108. Upstream of the fan-disc 106, a nose cone 105 is arranged.

Behind the fan 104, the turbofan engine 100 forms a secondary flow channel 109 and a primary flow channel 110. The primary flow channel 110 leads through the core engine (gas turbine) that comprises the medium-pressure compressor 111, the high-pressure compressor 112, the combustion chamber 113, the high-pressure turbine 114, the medium-pressure turbine 115, and the low-pressure turbine 116. At that, the medium-pressure compressor 111 and the high-pressure compressor 112 are surrounded by a circumferential housing 117 which forms an annulus surface at the internal side, delimitating the primary flow channel 110 radially outside.

During operation of the turbofan engine 100, a primary flow flows through the primary flow channel 110, which is also referred to as the main flow channel, and a secondary flow flows through the secondary flow channel 109, which is also referred to as bypass channel, wherein the secondary flow bypasses the core engine.

The described components have a common rotational or machine axis 200. The rotational axis 200 defines an axial direction of the turbofan engine. A radial direction of the turbofan engine extends perpendicularly to the axial direction.

Furthermore, the turbofan engine 100 comprises an Electronic Engine Control (EEC) unit 2 which is depicted schematically. The EEC unit 2 is a digital control unit that combines engine sensor information with cockpit instructions to ensure that the engine performs both safely and at an optimal level. It is typically mounted to the fan case of an engine. In the described embodiment, the EEC unit 2 is connected to an RFID reader 3 that automatically reads RFID tags of Line Replaceable Units (LRUs) of the turbofan engine, as will be explained in relation to FIGS. 2-5.

It is pointed out that the aircraft engine of FIG. 1 represents just one example of an aircraft engine in which the invention may be implemented. Other examples regard one shaft or three shaft turbofan engines and turboprop engines.

FIG. 2 shows an exemplary embodiment of an aircraft engine monitoring system. The monitoring system comprises a plurality, in the depicted case three LRUs 41, 42, 43 which are located in an aircraft engine 100. An LRU is a unit that may be removed and re-fitted from the aircraft engine 100 in field, i.e., without completely dismantling the aircraft engine or taking it to a workshop. The LRU may be a sealed unit. It may have standardized connections for rapid mounting, cooling air, power, and grounding. A plurality of components of an aircraft engine qualifies or may qualify as an LRU. Examples for LRUs include mechanical units such as a valve or a hydraulic pump, electrical units such as a switch or relay and electronic units such as an Air Turbine Starter or an Electronic Engine Control (EEC) unit.

Each LRU 41, 42, 43 is associated with an RFID tag 51, 52, 53. The RFID tag contains information that identifies the tag and thus the LRU to which the tag is connected or into which it is integrated. Such information is referred to as ID-information. Optionally, several IDs may be included in the RFID tags for separately identifying the RFID tag and the LRU associated with the RFID tag. In the context of the present invention, such several IDs are also referred to as ID-information. The RFID tags 51, 52, 53 may include further information such as information on parameters or characteristics of the LRU.

In one embodiment, the RFID tags 51, 52, 53 are embedded in hardware of the LRUs 41, 42, 43 such that the RFID tags and the LRUs cannot be physically separated.

The aircraft engine monitoring system further comprises an RFID reader 3 which is also installed in the aircraft engine 100 and a fixed part of the aircraft engine 100. The RFID reader 3 is located and configured such that it is able to read the RFID tags 51, 52, 53 of all LRUs 41, 42, 43 that are located in the aircraft engine 100. Depending on the signal strength, the RFID tags 51, 52, 53 may be passive, semi-active or active tags. The signal strength is to be adjusted such that the RFID reader 3 can read the information of all RFID tags 51, 52, 53.

Alternatively, two or more RFID readers are installed in the aircraft engine, each reader provided and configured to read a subset of the RFID tags of the engine LRUs.

The RFID tags 51, 52, 53 may broadcast and the RFID reader 3 may receive frequencies in any of the known RFID frequency bands (low frequency band (LF, 120-150 kHz), high frequency band (HF, 13.56 MHz), ultrahigh frequency band (UHF, about 850 to 950 MHz), or a microwave band).

The RFID tags 51, 52, 53 may be of conventional design. In particular, an RFID tag may comprise an integrated circuit for storing and processing information that modulates and demodulates radio-frequency signals, a circuit for collecting DC power from an incident reader signal and/or a battery, and an antenna for receiving and transmitting the signal. The tag information is stored in a memory. In a similar manner, the RFID reader 3 may be of conventional design. The RFID reader 3 may be an active reader or a passive reader depending on the design of the RFID tags.

The aircraft engine monitoring system further comprises an Electronic Engine Control (EEC) unit 2. As mentioned, the EEC unit 2 is a digital control unit that combines engine sensor information with cockpit instructions to ensure that the engine performs both safely and at an optimal level. As all other components, the EEC 2 is depicted only schematically.

In the embodiment depicted in FIG. 2, the RFID reader 3 is a separate component from the EEC 2. In alternative embodiments, the RFID reader 3 may be integrated into the EEC 2. Further, it is pointed out that the EEC 2 is also an LRU. It may be provided with an RFID tag in a similar manner als LRUs 41, 42, 43.

The EEC unit 2 communicates with an aircraft on-board communication unit 60 that is located in the aircraft 6. The communication may be by serial bus. The on-board communication unit 60 is designed and configured to transmit information received from the EEC unit 2 and/or other information to ground. The respective communication may take place via a wireless local network or telecommunication network if the aircraft is on ground and may take place via satellite communication if the aircraft is in the air. Information gathered by the RFID reader 3 is transmitted from the RFID reader 3 to the EEC to and from the EEC 2 to the on-board communication unit 60. From the on-board communication unit 60, this information is transmitted to the remote surveillance system 7 which may be the surveillance system of the manufacturer of the aircraft engine 100. The information transmitted to the remote surveillance system 7 may include additional information such as health information about the LRUs collected by sensors of the EEC 2, as will be discussed in the next paragraph.

In an embodiment the transmission of information from the on-board communication unit 60 to the remote surveillance system 7 takes place by means of an engine health monitoring system that is implemented between the aircraft (the EEC 2 and the on-board communication unit 60) and the remote surveillance system 7 to provide the remote surveillance system 7 with health information about the components of the aircraft engine 100. Such engine health monitoring systems are well known and described, e.g., in US 2016/0177856 A1. One purpose of such engine health monitoring system is to improve long-term scheduling of aircraft engine maintenance.

It will be appreciated that the transmission of information from the on-board communication unit 60 to the remote surveillance system 7 may include a plurality of intermediate nodes and communication links that are not described as they are not relevant for the present invention and comprised in the state of the art. In this sense, the on-board communication unit 60 as well as the EEC 2 participate in sending the ID information to the remote surveillance system 7.

A method of collecting data on aircraft engine maintenance by means of the aircraft engine monitoring system of FIG. 1 is explained with respect to FIG. 4. The RFID reader 3 is configured to read at least intermittently and automatically the RFID tags 51, 52, 53 of the LRUs 41, 42, 43 located in the aircraft engine 100. For example, such reading takes place upon each start of the aircraft engine. This way, it can be determined if an LRU has been replaced while the aircraft has been on the ground. Alternatively, the RFID reader may be configured to read the RFID tags 51, 52, 53 in different intervals, such as fixed time intervals. In principle, it can also be provided that the RFID reader 3 reads the RFID 51, 52, 53 tags in very short time intervals and thus essentially continuously.

Accordingly, in step 401 of FIG. 4 a reading session is started with the start of the aircraft engine 100. In step 402, the RFID tags 51, 52, 53 are read by means of the RFID reader 3. The read information includes ID-information that identifies the respective LRUs 41, 42, 43. At least this ID-information is sent from the RFID reader 3 to the EEC 2. To this end, the RFID reader 3 may be connected by wire with an input port of the EEC 2.

The read information is transmitted in step 403 of FIG. 4 to the remote surveillance system 7. To this end, the information is sent from the EEC 2 to the aircraft on-board communication unit 60 and from the aircraft on-board communication unit 60 to the remote surveillance system 7 in the manner discussed above.

By reading the ID-information of the LRUs, a determination can be made if an LRU has been removed and replaced by another LRU during maintenance work. This can be determined in a simple manner by determining if an LRU ID that has been read during the previous reading of the RFID tags is now missing and a new LRU ID is present. This analysis can be carried out in the aircraft engine 100 or at the remote surveillance system 7. Accordingly, in one embodiment the determination if an LRU has been replaced is made in the EEC 2. In another embodiment, such determination is made in the remote surveillance system 7. The respective method is the same in both cases and depicted by example in FIG. 5.

According to FIG. 5, the analysis is started by the reading of the RFID tags 51, 52, 53 of the LRUs 41, 42, 43, step 501. In step 502, the read IDs of the LRUs are compared with the previously read IDs of the LRUs. In step 503, if the ID of an LRU has changed, it is determined that the LRU has been replaced. In embodiments of the invention, this replacement information is linked with other available information related to the LRU. For example, the replacement information may be linked with information on accumulated hours and/or cycles of the LRU before removal, with information on the location of removal of the LRU and/or with information on the time of removal of the LRU. This additional information may be provided by sensors that are connected to the EEC unit 2, as will be explained with respect to FIG. 3. In step 505 of FIG. 5, the linked information is used for reliability assessments and lifecycle management in the remote surveillance system 7.

In one embodiment, the remote surveillance system 7 may receive additional information from an aircraft mechanic 80 who is maintaining the LRUs 41, 42, 43 on ground. Such aircraft mechanic 80 is also depicted in FIG. 2. The aircraft mechanic 80 has a mobile device 8 such as mobile phone or a tablet computer which is in communication with the remote surveillance system 7. The mobile device 8 has installed the specific app that allows the aircraft mechanic 80 to communicate with the remote surveillance system 7.

In particular, the aircraft mechanic 80 may sent by means of the mobile device 8 information to the surveillance system 7 regarding the condition of an LRU when being replaced or the time it took to replace the LRU. To identify an LRU, the mobile device may include or be coupled to an RFID reader that allows to read an RFID tag 51, 52, 53 by the aircraft mechanic 80. Further, the aircraft mechanic 80 may receive through the mobile device 8 information from the surveillance system 7 about specific LRUs and maintenance work to be performed thereon. Such information on maintenance work to be performed may depend on the information provided by the RFID reader 3.

FIG. 3 shows the LRUs 41, 42, 43, the RFID tags 51, 52, 53, the RFID reader 3 and the EEC 2 of FIG. 2 in more detail. More particularly, each LRU 41, 42, 43 is associated with one or several sensors 91, 92, 93 which are provided and configured to sense operational and health data of the LRUs 41, 42, 43.

The data sensed by the sensors 91, 92, 93 are provided to the EEC unit 2. More particularly, the EEC unit 2 comprises a controller 21 which receives the data from the sensors 91, 92, 93 and which also receives the data read by the RFID reader 3. The EEC unit 2 further comprises a power source 23, a mass storage memory 22 in communication with the controller 21 and in interface 24 for sending data to the aircraft on-board communication unit 60 of FIG. 2. It is pointed out that only the components of the EEC unit 2 relevant for the present invention are depicted in FIG. 3. The EEC 2 is a unit with further components and functionalities as known to the skilled person.

The RFID reader 3 comprises a reader 31 which transmits interrogator signals and also receives authentication replies from tags 51, 52, 53. The RFID reader 3 further comprises a temporary memory 32 in which, according to an embodiment, the received information is stored until it has been transmitted to the EEC unit 2. The RFID reader 3 may comprise additional components such as a battery.

The sensors 91, 92, 93 sense operational or health data of the LRUs 41, 42, 43 that are stored in memory 22 of the EEC unit 2. This health data can be linked to the ID-information provided by the RFID reader 3. For example, if the EEC unit 2 determines that one of the LRUs, e.g., LRU 41 has been replaced, it will provide the health data collected with respect to the now replaced LRU to the remote surveillance system 7 together with the ID-information. The linking of the health information to the information that the LRU has been replaced may take place at the level of the EEC unit 2 or at the level of the remote surveillance system 7. Further information may be linked to the ID-information in particular at the level of the remote surveillance system 7 as discussed above.

It should be understood that the above description is intended for illustrative purposes only, and is not intended to limit the scope of the present disclosure in any way. For example, the manner in which the read ID-information is transmitted to a remote surveillance system 7 is described by example only. Alternative ways to transmit information to the remote surveillance system 7 may be implemented. For example, the EEC unit 2 could be designed such that it can directly send information to ground and thus to the remote surveillance system 7. In another example, the RFID reader 3 communicates directly—and not through EEC 2—with the aircraft on-board communication unit 60.

Also, those skilled in the art will appreciate that other aspects of the disclosure can be obtained from a study of the drawings, the disclosure and the appended claims. For example, while the invention has been described in the drawings with respect to an aircraft unit that is an aircraft engine, the invention may be implemented in a similar manner in other aircraft units such as a Landing Gear Unit or an Engine Vibration Monitoring Unit.

All language of distinction and disparagement with respect to certain features is intended to indicate a lack of preference for those features, but not to exclude such from the scope of the disclosure entirely unless otherwise indicated. All methods described herein can be performed in any suitable order unless otherwise indicated herein or otherwise clearly contradicted by context. Various features of the various embodiments disclosed herein can be combined in different combinations to create new embodiments within the scope of the present disclosure. Any ranges given herein include any and all specific values within the range and any and all sub-ranges within the given range.

1-21. (canceled)

22. An aircraft monitoring system, comprising:
at least one Line Replaceable Unit (LRU) installed in an aircraft unit, the LRU comprising a Radio Frequency Identification (RFID) tag, the RFID tag containing stored information which consists of or comprises ID-information identifying the LRU, and
an RFID reader installed in the aircraft unit, the RFID reader being located and configured to at least intermittently automatically read the RFID tag of the at least one LRU,
wherein the RFID reader is configured to transmit at least the read ID-information to an aircraft communication unit for determining from the received ID-information if an LRU has been or shall be replaced, wherein the communication unit participates in sending the ID-information to a remote surveillance system.

23. The aircraft monitoring system of claim 22, wherein the RFID reader is configured to read the RFID tag periodically, especially after defined time intervals and/or upon predefined events that occur repeatedly.

24. The aircraft monitoring system of claim 22, wherein the RFID reader is configured to read the RFID tag upon each start of the aircraft or aircraft engine.

25. The aircraft monitoring system of claim 22, wherein the RFID tag is a passive or semi-active tag, the aircraft monitoring system especially comprising a plurality of passive, semi-active and/or active tags, preferably comprising at least one semi-active or active tag.

26. The aircraft monitoring system of claim 22, wherein the RFID tag is embedded in hardware of the LRU.

27. The aircraft monitoring system of claim 22, wherein the RFID reader is located inside, outside or near an Electronic Control Unit of the aircraft unit, or in that the RFID reader is a separate component from the Electronic Control Unit.

28. The aircraft monitoring system of claim 22, wherein the aircraft communication unit to which the RFID reader transmits the ID-information read from the RFID tag is an Electronic Control Unit of the aircraft unit or an on-board communication unit located in the aircraft; and/or in that the aircraft communication unit to which the RFID reader transmits the ID-information read from the RFID tag is designed and configured to participate in transmitting the read ID-information to the remote surveillance system by means of a Health Monitoring system that has been implemented to transmit health information about aircraft components to the remote surveillance system.

29. The aircraft monitoring system of claim 22, wherein the aircraft communication unit to which the RFID reader transmits the ID-information read from the RFID tag is configured to determine from the ID information if an LRU has been replaced and, if so, to transmit such replacement information together with the read ID-information to the remote surveillance system.

30. The aircraft monitoring system of claim 22, wherein the communication unit is configured to link ID-information regarding an LRU with at least one of the following additional information:
accumulated hours and/or cycles of the LRU before removal,
location of removal of the LRU,
time of removal of the LRU,
wherein the additional information is transmitted together with the ID-information to the remote surveillance system.

31. The aircraft monitoring system of claim 22, wherein the aircraft unit is an aircraft engine.

32. A method for collecting data on aircraft maintenance, the method comprising:
automatically reading at least intermittently by means of an RFID reader which is located in an aircraft unit ID-information contained in at least one Radio Frequency Identification (RFID) tag comprised in a Line Replaceable Unit (LRU) of the aircraft unit, each RFID tag containing ID-information identifying the respective LRU, the ID-information being automatically read periodically, and
transmitting the read ID-information to a remote surveillance system.

33. The method of claim 32, wherein the ID-information is read after defined time intervals and/or upon predefined events that occur repeatedly, especially at least upon predefined events including each start of the aircraft or aircraft engine.

34. The method of claim 32, wherein the read ID-information is transmitted to the remote surveillance system by means of a Health Monitoring system that transmits health information about aircraft components from the aircraft to the remote surveillance system; and/or in that the ID information read from the RFID tag is interpreted to determine if an LRU of the aircraft unit has been replaced and that this information is gathered at the remote surveillance system.

35. The method of claim 32, wherein ID-information regarding an LRU is linked with at least one of the following additional information:
accumulated hours and/or cycles of the LRU before removal,
location of removal of the LRU,
time of removal of the LRU,
time to remove the LRU and install a replacement LRU.

36. A surveillance system for collecting data on aircraft maintenance, wherein the surveillance system is configured to
receive from an aircraft communication unit ID-information regarding at least one LRU of an aircraft unit, each ID-information being contained in an RFID tag of an LRU and identifying an LRU, the ID-information being automatically read periodically, and
determine from the received ID-information if an LRU has been replaced.

37. The surveillance system of claim 36, wherein the surveillance system is further configured to link a replacement information regarding an LRU with at least one of the following additional information:
accumulated hours and/or cycles of the LRU before removal,
location of removal of the LRU,
time of removal of the LRU,
time to remove the LRU and install a replacement LRU.

38. The surveillance system of claim 36, wherein the surveillance system is further configured
to provide such ID-information or information deducted therefrom to service personal units for use of such information by service personal when maintaining an LRU, and
to receive from such service personal units additional information about LRUs and maintenance work performed thereon.

39. The surveillance system of claim 36, wherein the surveillance system is further configured to receive information from a stock or repair facility about a replaced LRU, the stock or repair facility identifying a replaced LRU by means of its RFID tag.

40. A software application product storable and operable in a mobile device that includes a graphical user interface, the software application product when executed on a processor in the mobile device being operative to:
receive from a remote surveillance system information on at least one Line Replaceable Unit (LRU) of an aircraft unit that has been or that shall be replaced, the information including ID-information contained in a Radio Frequency Identification (RFID) tag comprised in the LRU, the ID-information being automatically read periodically, and
provide to the remote surveillance system information about such LRU and/or maintenance work performed thereon.
